(19) United States
(12) Patent Application Publication
(10) Pub. No.: US 2017/0144324 A1
(43) Pub. Date: May 25, 2017

(54) Drywall Splitter

(71) Applicant: Richard Thib Thibault, New Britain, CT (US)

(72) Inventor: Richard Thib Thibault, New Britain, CT (US)

(21) Appl. No.: 14/757,130

(22) Filed: Nov. 24, 2015

(51) Int. Cl. B26F 3/00; E04F 21/00

(52) U.S. Cl. CPC B26F 3/002; E04F 21/0076

(57) ABSTRACT

A drywall or similar planar material cutting tool is provided that aids in the achieving of clean and square cuts with minimal debris and/or breakage to the drywall material edge. The apparatus defines a generally J-shaped engagement channel, or combinations of J-shaped channels, to engage the edge of a drywall sheet, and a centrally affixed handle located perpendicular to the bottom surface of the J-channel and generally in a parallel plane to the drywall sheet being cut. The unique configuration allows pressure applied to the handle to be uniformly transferred to the J-channel which, in turn, applies a uniformly distributed shear force. The applied force is perpendicular to the plane of the drywall sheet and, at all times, parallel to the pre-applied score mark thereby resulting in a clean snap break of the board with an improved edge quality.

### CROSS-REFERENCE

Priority and benefit of earlier filing date of provisional application Ser. No. 61/212,113 filed Apr. 7, 2009, is claimed.

### FIELD OF THE INVENTION

The present invention relates to a tool for splitting or “breaking” drywall board or similar planar material after the desired cut has been scored. Drywall is a common building material that is typically formed by a layer of gypsum plaster pressed between two thick sheets of paper and then the composite is kiln dried. Drywall is generally used for the finish construction of interior walls and ceilings. Drywall is also commonly known as gypsum board, wallboard, plasterboard, Sheetrock® (a trademark of United States Gypsum Company), or simply board.

The present invention relates to an apparatus which can be utilized for cutting drywall material. More particularly, this invention can be customized to suit a plurality of drywall lengths and sizes. The present invention also has a means for attaching a pole to the existing handle to provide for an extended reach or use of the device.

Typically, a T-square or tape-measure would be set on the top edge of a sheet of drywall in order to establish the required measurement and location of a desired cut on the drywall sheet. A utility knife would then be run along the side of the “T” or held at the end of the measuring tape to score the cut through the outer paper laminate on one side of the board. The user would then “snap” the drywall material backward to break the drywall along the score line. This rather uncontrolled application of break forces often results in debris, broken edge material and otherwise less-than-optimal board edge quality requiring application of time-consuming edge-dressing techniques or resulting in gaps in the adjoining sheets of drywall.

### BACKGROUND OF THE INVENTION

### Brief Description of the Related Art

Because of their size, and the large surface area generally being covered by drywall sheets, drywall construction requires multiple sheets to be adjoined together in an abutting manner. To accomplish the necessary multiple flush abutments between adjoining drywall sheets, while accommodating the geometric requirements of the surface being covered, a drywall worker must make repetitive cuts in the drywall that are true, straight and of sound edge structural integrity over long distances. The industry has adopted the typical practice of using some type of cutting “guide” to create a straight score cut line on one side of the drywall in order to just break through the paper laminate and then secondarily applying a force on both sides of the score line while coincidentally applying an opposing force on the drywall board on the opposite side of the drywall and approximately behind the score cut in order to “snap” the interior layer of gypsum plaster. A standard utility knife is utilized to make both the initial score cut and the final cut through the second layer of paper laminate after the snap has occurred to complete the separation.

Many tools, devices and specialized cutters have been designed and manufactured to aid in the cutting of a specified size of drywall. However, these tools and devices are complicated and typically make the scoring or cutting of drywall very cumbersome. Furthermore, these tools and devices generally do not assist in breaking the board after the initial score is made and such tools and devices generally do not improve the quality of the resulting break.

In one example of the prior art, U.S. Pat. No. 5,600,892 to Peugh discloses a rather intricate apparatus for simultaneously cutting both sides of a drywall sheet by adjusting parallel cutter holding support columns at the same distance from a drywall board edge on which a guide assembly is positioned and traversed in order to accomplish the cut. The device must be carefully and evenly slipped over the edge of the drywall board in order to avoid inadvertent board edge breakage or damage causing waste. Such careful manipulations are cumbersome and time consuming for the worker.

In another example of the prior art, U.S. Pat. No. 6,289,594 to Wrobbel discloses a device comprising a U-shaped channel with an integral flat stem section which incorporates a plurality of guide apertures for marking or guiding a utility knife as the U-shaped channel is moved along a drywall board edge. This device is only useful for marking or performing the initial score cut and is not intended to be, nor in practice is, of any aid in the snapping of the board. Similarly, U.S. Pat. No. 7,481,001 to Rao discloses a T-square configured with a plurality of rollers contained in a U-shaped member to facilitate rolling along the edge of a drywall sheet while the measuring “ruler” section, which lies flat on the drywall board surface to be cut, incorporates an adjustable blade holder and cutting blade. Likewise, PCT Pat. Application No. WO 00/35641 to Walker discloses an apparatus comprising a U-shaped board edge locating means which supports a graduated spacer bar in a T-shape on which a slideable cutting device is located. Again, these devices are merely intended for marking and performing the initial score cut and are not intended to be, nor in practice are, of any aid in the snapping of the board. In yet another example of prior art, U.K. Pat. Application No. GB 2307879 to Santucci discloses an upper plate, lower plate and intervening block to define a slot in which the edge of a drywall board may be inserted but only for the purpose of securing a tool such as a spirit level or a ruler.

### SUMMARY OF THE INVENTION:

It is an object of the present invention to allow for making improved edge quality square cuts in a plurality of lengths with a drywall splitter after the board has been scored by positioning the device of the present invention directly onto the edge of drywall material adjacent and parallel to the intended cut. With such a device engaged on the board edge, followed by applying a small amount of force to a centrally located handle, a uniform breaking force is applied perpendicular to the plane of the drywall sheet causing a bending moment which is at all times parallel to the score cut, causing the drywall to snap making a clean cut with minimal debris and/or breakage to the existing drywall material.

The preferred embodiment of the present invention comprises a single J-shaped channel intended to engage the edge of the drywall board, and a substantially perpendicularly affixed handle centrally located on the bottom of the J-shaped channel and extending substantially in the opposite direction from pocket of the J-shaped channel. This J-shaped section comprises a Back Plate, a relatively shorter Front Plate, and a bottom section or Middle Holding Segment; the Back Plate connected to the Middle Holding Segment at a substantially right angle; and the Front Plate connected to the Middle Holding Segment at a substantially right angle and substantially parallel to the Back Plate. The Handle may be fixed to the J-shaped channel by any number of traditional methods such as, but not limited to, being molded in one piece, welded, mating mechanical threads, clamped, bolt and screw or spring loaded detent button. The removable Handle options facilitate ease of transport and storage in typical toolboxes, buckets, etc.

In an alternative embodiment of the present invention, a second J-shaped channel is located back-to-back with the first described single J-shaped channel, along the longer Flange described as the Back Plate above, and more specifically the Central Flange in the double J-shape embodiment, such that the pockets formed are substantially parallel to each other with the pocket openings facing in substantially the same direction. A substantially perpendicularly handle is centrally affixed on the bottom of the double J-shaped channels and extending substantially in the opposite direction from pocket openings of the double J-shaped channels. The double J-shaped embodiment provides for convenient drywall thickness variation accommodation as well as a choice in the optimal engagement Flange length for the cut being performed.

### BRIEF DESCRIPTION OF THE DRAWINGS:

FIG. 1A is a side elevation view of the single J-shaped Splitter showing the J-shaped channel and the centrally located Handle.

FIG. 1B is a top planar view of the single J-shaped Splitter showing the J-shaped channel and the centrally located Handle.

FIG. 2A is a cross-sectional view of the single J-shaped Splitter showing the J-shaped channel and the centrally located Handle at Section A-A from FIG. 1.

FIG. 2B is a perspective view of the single J-shaped Splitter showing the J-shaped channel and the centrally located Handle.

FIG. 3 is a side elevation view of the Splitter engaged on the edge of a typical sheet of Drywall board in which the solid line represents the scored cut and the dotted line represents an alternative scored cut on the reverse side of the Drywall board. The Splitter is shown in each the horizontal cut and the vertical cut orientations.

FIG. 4 is a side elevation view of the single J-shaped Splitter engaged on a sheet of Drywall for each a horizontal and a vertical cut respectively.

FIG. 5 is a top planar view of the single J-shaped Splitter engaged on a sheet of Drywall for each a horizontal and a vertical cut respectively.

FIG. 6 provides two side elevation views of the single J-shaped Splitter engaged on a sheet of Drywall after applying a force to the handle and performing a horizontal cut snap of the board.

FIG. 7 provides a perspective view and a side elevation view of the single J-shaped Splitter engaged on a sheet of Drywall after applying a force to the handle and performing a cut snap of the board.

FIG. 8A is a side elevation view of the double J-shaped Splitter showing the double J-shaped channel and the centrally located Handle.

FIG. 8B is a top planar view of the double J-shaped Splitter showing the double J-shaped channel and the centrally located Handle.

FIG. 9A is a cross-sectional view of the double J-shaped Splitter showing the double J-shaped channel and the centrally located Handle at Section B-B from FIG. 8A.

FIG. 9B is a perspective view of the double J-shaped Splitter showing the double J-shaped channel and the centrally located Handle.

### DESCRIPTION OF THE PREFERRED EMBODIMENT

Although the disclosure hereof is detailed and exact to enable those skilled in the art to practice the invention, the physical embodiments therein disclosed merely exemplify the invention which may be embodied in other specific structure. While the disclosed preferred embodiments have been described, the details may be changed without departing from the invention, which is defined by the claims.

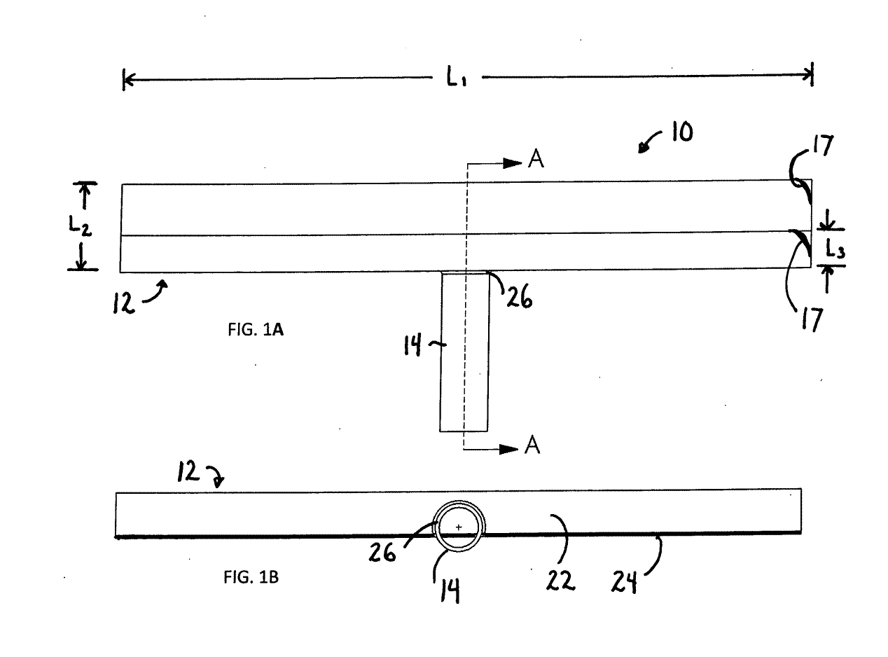

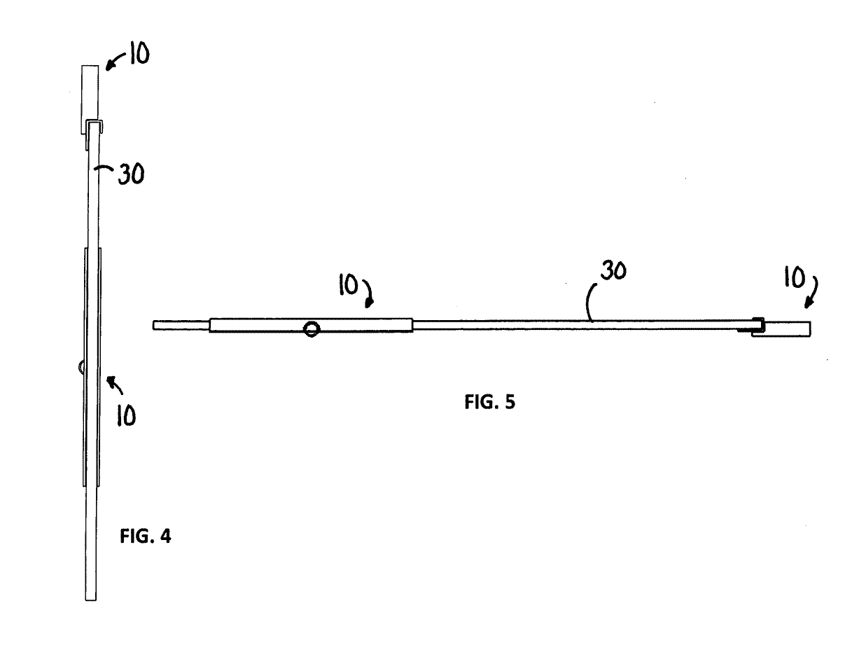

Referring to the drawings, wherein like referenced characters designate corresponding parts throughout the several figures, a preferred embodiment of the invention 10 is shown in FIGS. 1 through 7.

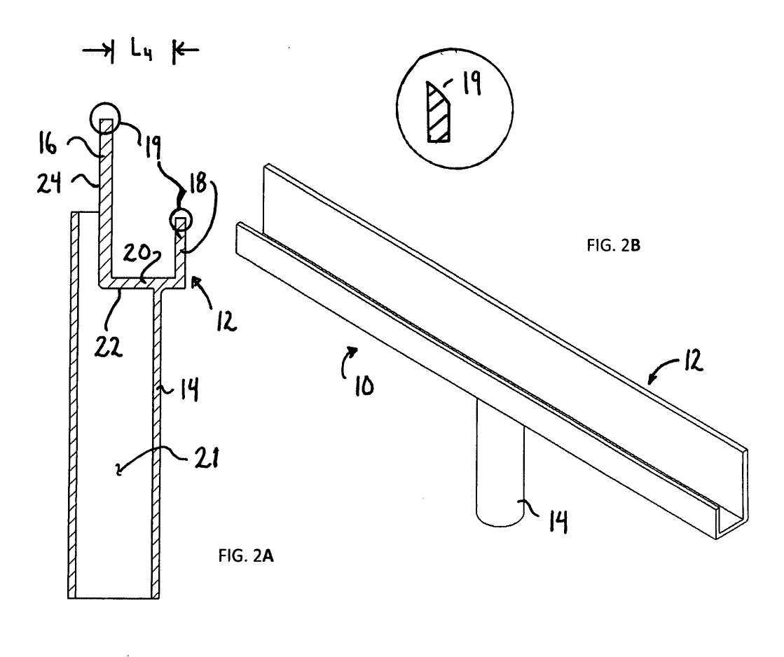

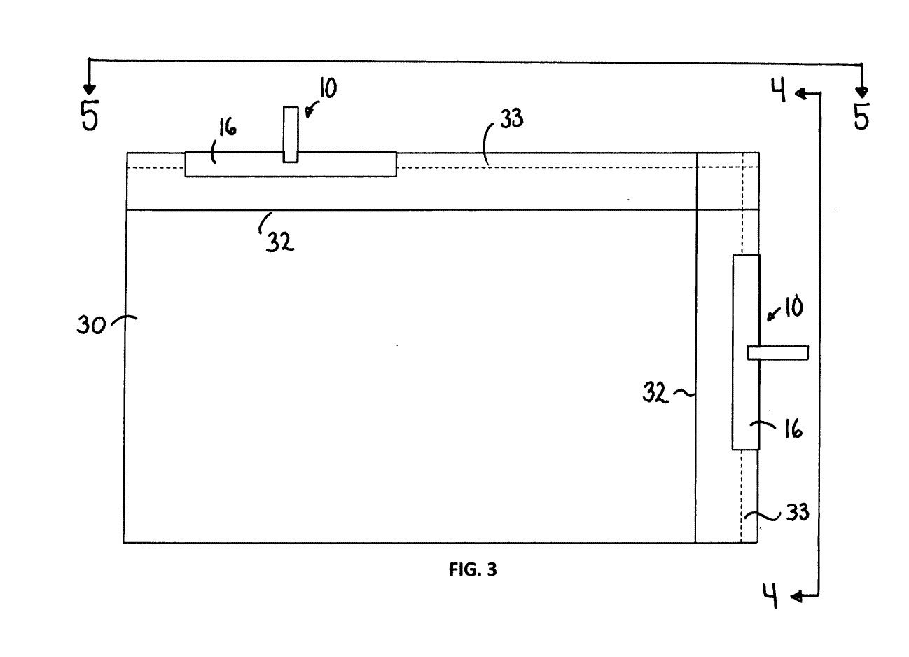

As shown in FIGS. 1A and 1B, the drywall splitter 10 comprises a J-shaped holding fixture 12 and a handle 14. As shown in FIGS. 2A and 2B, holding head fixture 12 defines a back plate surface 16, a frontal plate surface 18, and a middle holding segment 20. The middle holding segment 20 defines the gap formed between the back plate 16 interior surface and the frontal plate 18 interior surface; and may be fabricated to accommodate the splitting of a broad range of board 30 (shown in FIG. 3) thicknesses but most typically a thickness ranging from about ¼ inch in thickness to approximately 1 inch or more in thickness.

In a preferred embodiment, the back plate 16 is taller than the frontal plate 18 in order to apply and distribute the snapping force over a large area of the board. The middle holding segment 20 ensures that the splitter 10 is always normal to the edge of the board being cut and parallel to the score line while the shorter frontal plate 18 imposes a clamping force which locks the splitter 10 tool onto the board 30 when a force is applied to the handle 14. The interior surfaces of the back plate 16 and frontal plate 18 may be tapered, draft angled or rounded 19 to aid in guiding the engagement of the device 10 onto the board 30. Further, in the preferred embodiment, the top corners at each extreme end of the back plate 16 and frontal plate 18 have been rounded 17 or incorporate other geometry to guard against inadvertent personal injury and/or scaring or damaging of the board 30 while engaging or manipulating the device 10.

FIG. 1B illustrates a top view of the drywall splitter 10 looking down the axis of the handle 14. Together with FIG. 2B the handle 14 is shown offset from the center of the middle holding segment 20 outer surface 22 and attached at location 26. While the handle 14 may be circumferentially affixed perpendicular or at a skewed angle to the middle holding segment 20 outer surface 22, the preferred embodiment provides for increase structural integrity by also affixing the handle 14 to the back plate 16 outer surface 24. This configuration represents the preferred embodiment when the splitter 10 is manufactured from either a welded, glued or molded process, likewise, the J-shaped holding head channel 12 may be manufactured by any number of traditional methods such as machining, welding, gluing, injection molding and extrusion.

In alternative embodiments, the handle 14 may be removeably joined to the bottom surface 22 of the J-shaped holding head channel 12 by any number of known conventional means such as, for example, a nut and bolt, male/female receptacles, twist lock mechanism, spring locks, etc. to form a hand-tool sized device or simply for ease of packing and transport including inside toolboxes and tool buckets, etc.

The handle 14 configuration is not limited to the depicted hollow tube 21; however, the tube facilitates the easy insertion of and extension pole if desired. Such optional handle 14 extensions can also be accomplished in any number of the traditional methods such as being threaded like a broom handle, pinned, sleeved, keyed or sprung loaded detent button to facilitate extended reach or use of the device. The handle 14 may also incorporate a machined, molded or slip-on style hand-grip such as is used on bicycle handlebars.

FIGS. 3, 4 and 5 show the splitter device 10 engaged on the edge of a board 30 such that the middle holding segment 20 ensures that the splitter 10 is always normal to the edge of the board being cut and parallel to the score line 32. The splitter 10 is further oriented such that the longer back plate 16 is positioned on the same plane of the board 30 which has been scored 32 while the shorter frontal plate 18 is positioned on the side of the board 30 opposite of the score line 32. The dotted line 33 in FIG. 3 represents an alternative score line if the desired cut was less than the height L2 of engagement of the longer back plate 16.

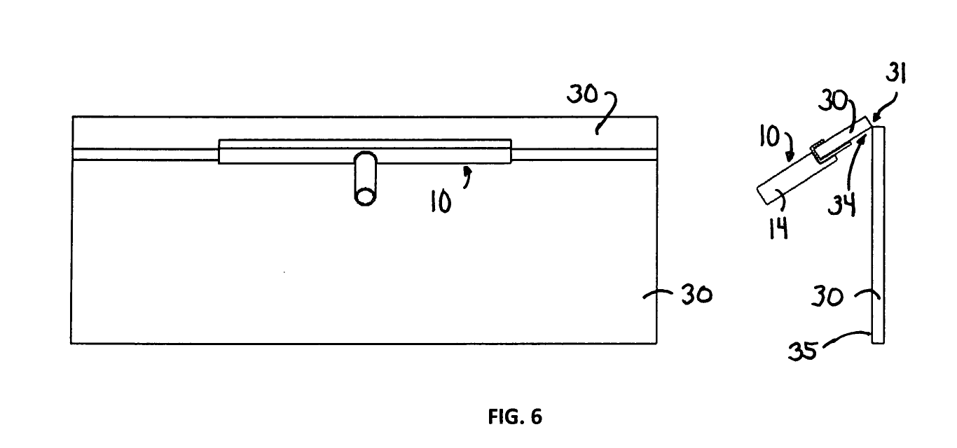

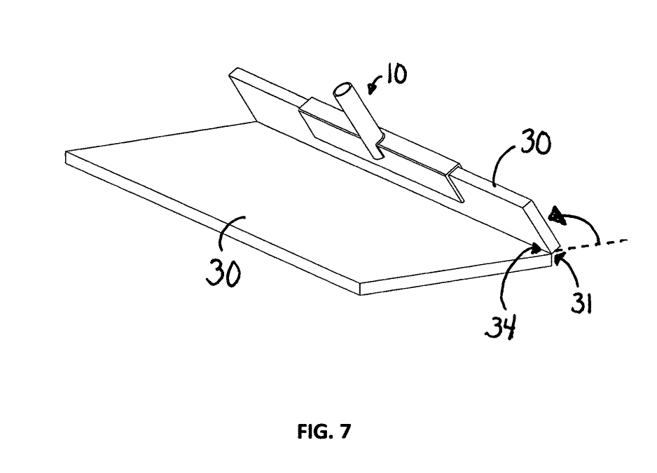

When a slight force is applied to the centrally located handle 14, this force is transmitted over the entire square area defined by the length L1 and the height L2 of the back plate 16 of the J-shaped holding fixture 12 to ensure that a uniform breaking force is applied perpendicular to the plane of the drywall sheet 30. As shown in FIG. 6, the force applied to the handle 14 also causes a bending moment which is at all times parallel to the score cut 32, further causing the drywall 30 to snap with a clean cut 31 with minimal debris and/or breakage to the existing drywall material. FIGS. 6 and 7 depict the orientation of the splitter device 10 and the board 30 immediately following the snap of the board 30 along the scored line 32. The worker would then use the “V” 34 opposite the clean cut 31 formed on the back side of the board 30 created by the non-scored second laminate wall board paper 35 serving as a temporary hinge connecting the two severed board 30 segments, to guide a utility knife or other cutter to sever the second paper laminate 35 and complete the cut. The worker has the option of either pushing or pulling on the handle 14 and thus has the flexibility as the case warrants to be positioned on either side of the board 30 being cut.

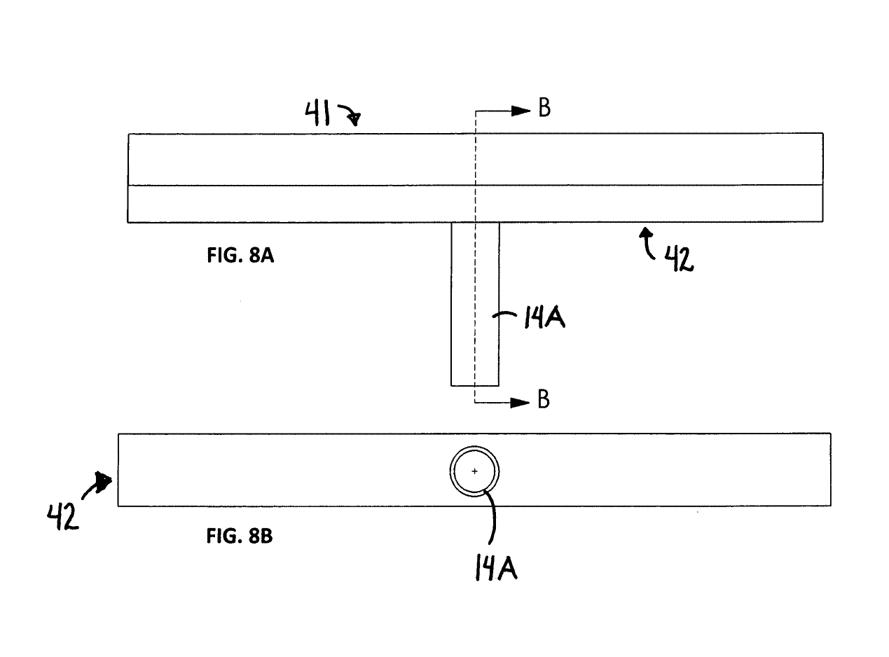

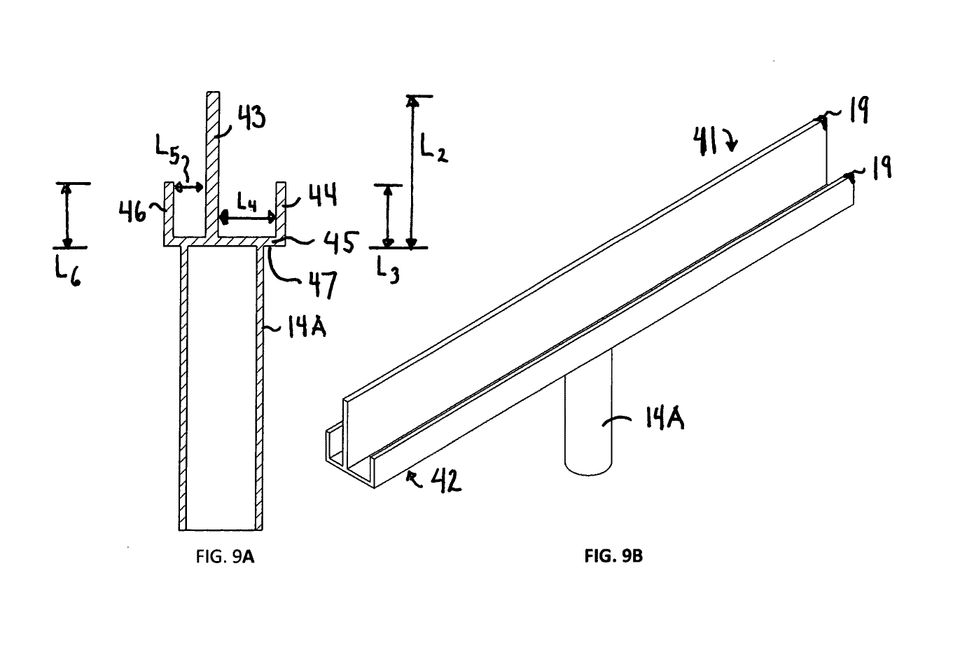

An alternative embodiment is shown in FIGS. 8A, 8B, 9A and 9B, in which the drywall splitter 41 comprises a double J-shaped holding fixture 42 and a handle 14A. As shown in FIGS. 9A and 9B, holding head fixture 42 defines a back plate surface 43, a first frontal plate surface 44, a second frontal plate surface 46 and a middle holding segment 45 that spans all three vertical segments. The middle holding segment 45 defines the gap formed between the back plate 43 corresponding interior surfaces and each respective first frontal plate 44 interior surface and the second frontal plate 46 interior surface; and may be fabricated to accommodate the splitting of a broad range of board 30 thicknesses but most typically ranging from about ¼ inch in thickness to approximately 1 inch or more in thickness.

The principal advantage of the double J-shaped holding fixture 42 is that each L4 and L5 can be optimised for two different size board 30 thicknesses or range of thicknesses. In the preferred embodiment, the back plate 43 is longer than both the first frontal plate 44 and the second frontal plate 46 in order to apply and distribute the snapping force over a large area of the board 30. Further, first frontal plate 44 length L3 and the second frontal plate 46 length L6 can likewise be varied in length to correspond to their particular board 30 gap width L4 and L5 respectively. The middle holding segment 45 ensures that the splitter 41 is always normal to the edge of the board being cut and parallel to the score line, while the shorter frontal plate 44 or 46 imposes a clamping force which locks the splitter 41 onto the board when a force is applied to the handle 14A.

FIG. 8B illustrates a top view of the drywall splitter 41 looking down the axis of the handle 14A. FIGS. 8A, 8B, 9A and 9B depict the handle 14A (as previously described above for handle 14) centrally located on the center of the middle holding segment 45 outer surface 47. The double J-shaped holding fixture 42 extra-wide double J-channel middle holding segment 45 provides for a larger outer surface 47 than is practical for the single J-shaped holding fixture middle holding segment 20 outer surface 22. Therefore, the handle is more readily circumferentially affixed to the middle holding segment 45 outer surface 47. The worker merely selects the optimum double J-shaped holding fixture 42 pocket and then uses the tool as described for the single J-shaped splitter device 10.

A preferred embodiment of the device is fabricated from metal, preferably light weight aluminum; however, any suitably rigid material will suffice. A device fabricated from metal may be formed by any number of known means such as by machining, stamping, forming, shaping, casting, extrusion and the like. The device also may be fabricated from suitably hard plastic or resin and formed by any number of known means such as by mold injection, extrusion, and the like.

What is claimed as new and desired to be secured by Letters Patent of the United States is:

1. An apparatus for splitting a sheet of stock planar material having opposed planar side surfaces and a guiding planar material edge surface joining each of said planar side surfaces, the stock planar material having been pre-scored on one side by conventional means in a straight line parallel to the material edge, the apparatus comprising:
a) at least one structural channel defining an interior cavity wherein the interior cavity engages the planar material edge surface; and
b) at least one structure member handle approximately centrally located on the overall length of the structural channel, substantially perpendicular to the structural channel and fixed in a direction substantially opposite of the structural channel interior cavity.

2. The splitter apparatus of claim 1 wherein the structural channel interior cavity further comprises:
a) an interior cavity longitudinal length;
b) a substantially flat middle holding segment intended to sit normal on the edge of the planar material and comprising a middle holding segment longitudinal length approximately equal to the interior cavity longitudinal length; and
c) two flanges positioned substantially perpendicular to-the middle holding segment and substantially parallel to each other and comprising a flange longitudinal length approximately equal to the interior cavity longitudinal length.

3. The splitter apparatus of claim 2 wherein the two flanges comprise a front plane flange and a back plane flange, the front plane flange defines a front plane flange height relative to the middle holding segment, the back plane flange defines a back plane flange height relative to the middle holding segment, and the back plane flange height is greater than the front plane flange height.

4. The splitter apparatus of claim 2 wherein the two flanges comprise a front plane flange and a back plane flange, the front plane flange defines a front plane flange height relative to the middle holding segment, the back plane flange defines a back plane flange height relative to the middle holding segment, and the back plane flange height is substantially greater than the front plane flange height.

5. The splitter apparatus of claim 3 wherein said back plane flange and front plane flange have interiorly tapered, draft angled or rounded leading edge portions.

6. The splitter apparatus of claim 1 wherein the handle is substantially perpendicular to and permanently affixed to or structurally integral with the structural channel.

7. The splitter apparatus of claim 6 wherein the handle is circumferentially attached to the outer surface of the flat middle holding segment.

8. The splitter apparatus of claim 7 wherein the handle is structurally affixed to or structurally integral with at least one of the front plane flange or the back plane flange.

9. The splitter apparatus of claim 1 wherein the handle is attachable and removable from the structural channel by any one of several common fastening techniques.

10. The splitter apparatus of claim 1 wherein the handle is collapsible relative to the structural channel by any one of several common fastening techniques for ease of storage and transport.

11. The splitter apparatus of claim 1 wherein the handle is hollow or tubular in structure to facilitate the insertion of an extension pole or other extension device.

12. The splitter apparatus of claim 1 wherein an extension pole or other device is fastened to the handle by any one of several common fastening techniques.

13. The splitter apparatus of claim 1 wherein the extreme longitudinal corner edges of at least one of the front plane flange or the back plane flange defines a rounded geometry, a radius, or other geometry to prevent inadvertent personal injury or damage to the stock planar material.

14. The splitter apparatus of claim 1 wherein at least two structural channels are incorporated in a substantially parallel fashion.

15. The splitter apparatus of claim 14 further comprising:
a) a first structural channel defining a first interior cavity having a first interior cavity longitudinal length;
b) a second structural channel defining a second interior cavity having a second interior cavity longitudinal length;
c) a substantially flat first middle holding segment comprising a first middle holding segment longitudinal length approximately equal to the first interior cavity longitudinal length;
d) a substantially flat second middle holding segment comprising a second middle holding segment longitudinal length approximately equal to the second interior cavity longitudinal length; and
e) at least one structure member handle approximately centrally located on the overall length of the first structural channel or the second structural channel, substantially perpendicular to the first structural channel or the second structural channel, and fixed in a direction substantially opposite of the first structural channel or the second structural channel respective interior cavity.

16. The splitter apparatus of claim 15 wherein the first structural channel and the second structural channel comprise a common structural bottom or middle holding segment.

17. The splitter apparatus of claim 16 wherein the first interior cavity and the second interior cavity further comprise:
a) a common central structural back plane flange positioned substantially perpendicular to the middle holding segment defining a back plane flange height relative to the middle holding segment;
b) a first interior cavity front plane flange defining a first interior cavity front plane flange height relative to the middle holding segment;
c) a second interior cavity front plane flange defining a second interior cavity front plane flange height relative to the middle holding segment; and
d) wherein the back plane flange height is greater than the first interior cavity front plane flange height and the second interior cavity front plane flange height.

18. The splitter apparatus of claim 17 wherein the back plane flange height is greater than the first interior cavity front plane flange height and the second interior cavity front plane flange height.
